(19) United States
(12) Patent Application Publication
(10) Pub. No.: US 2007/0094115 A1
(43) Pub. Date: Apr. 26, 2007

(54) Agricultural transaction system involving non-agricultural inputs

(75) Inventors: Dennis Inman, Eden Prairie, MN (US); Jeffery C. Seeley, Chanhassen, MN (US); Mark A. Tracy, Minneapolis, MN (US); Eric Glenn, Plymouth, MN (US)

Correspondence Address: SHUMAKER & SIEFFERT, P. A., 1625 RADIO DRIVE, SUITE 300, WOODBURY, MN, 55125, US

(73) Assignee: Cargill, Inc., Minneapolis, MN (US)

(21) Appl. No.: 11/544,299

(22) Filed: Oct. 6, 2006

Related U.S. Application Data
(60) Provisional application No. 60/724,580, filed on Oct. 7, 2005.

(51) Int. Cl. G06Q 40/00

(52) U.S. Cl. 705/35

(57) ABSTRACT

The disclosure describes methods for performing agricultural transactions involving the exchange of inputs, such as agricultural equipment, non-equipment agricultural inputs, and non-agricultural inputs, in consideration of a commitment to deliver a specified quantity of an agricultural commodity over a specified period of time. In consideration of the commitment and, in some cases, a payment, the agricultural producer receives the inputs. In effect, the payment may result in a substantial discount of the price that the agricultural producer would otherwise pay for the inputs. The methods also may be applicable to exchange of non-agricultural commodities.

This application claims the benefit of U.S. Provisional Application Ser. No. 60/724,580, filed Oct. 7, 2005, the entire content of which is incorporated herein by reference.

### TECHNICAL FIELD

The invention relates to the agriculture business and, more particularly, to transactions involving agricultural commodities.

### BACKGROUND

A producer of a commodity generally requires various materials and equipment to produce the commodity. For example, an agricultural producer desiring to produce an agricultural commodity requires the necessary inputs to produce the agricultural commodity. The agricultural producer may be a farmer that produces products such as grains, oilseeds, fruit, vegetables, cotton, livestock, livestock byproducts, roots, herbs, shrubs, trees, and the like. In the agricultural example, inputs may include materials and equipment such as seed, fertilizer, pre-emergent herbicide, post-emergent herbicide, and insecticide, as well as capital equipment such as irrigation equipment, planting equipment, livestock shelters, livestock feeders, harvesting equipment, drying equipment, and storage facilities. In addition, the agricultural producer may require or benefit from non-agricultural inputs to produce the agricultural commodity, such as health and retirement investment accounts for the producer, family members of the producer, or employees of the producer.

The agricultural producer pays the cost of the inputs at the time of purchase of the inputs, or finances the cost of inputs through a retailer or lending institution. This cost becomes a substantially fixed cost associated with producing the agricultural commodity. Regardless of the manner in which an agricultural producer chooses to pay for inputs, the agricultural producer desires that revenue from the sale of the agricultural commodity will cover the cost of the inputs, as well as other production costs. The agricultural producer also desires that the revenue will provide a profit.

Whether the agricultural producer will recover the costs of producing the agricultural commodity and whether the agricultural producer will realize a profit often are not known until the end of the growing season. The agricultural producer receives a payment price upon sale or delivery of the agricultural commodity. The payment price is usually a function of a market price for the agricultural commodity, which may rise or fall during the growing season, creating additional uncertainty.

### SUMMARY

The invention is directed to methods and systems for performing agricultural transactions involving the exchange of inputs, such as agricultural equipment, non-equipment agricultural inputs, and non-agricultural inputs, in consideration of a commitment to deliver a specified quantity of an agricultural commodity over a specified period of time. In consideration of the commitment and, in some cases, a payment from an agricultural producer, the agricultural producer receives the inputs.

The payment is not necessarily in exchange for the inputs per se. Rather, the payment forms part of the consideration for the transaction, in combination with the commitment to deliver the commodity. However, the producer does not generally need to make a separate payment for the inputs. Therefore, the effect of the commitment and the payment may be a substantial discount in the price that the agricultural producer would otherwise pay for the inputs.

The discount may result in a reduced cost, or potentially no cost, for delivery of the agricultural equipment, non-equipment agricultural inputs, and/or non-agricultural inputs to the producer. The agricultural equipment, non-equipment agricultural inputs, and non-agricultural inputs may be delivered once or multiple times. The period of the producer's commitment may extend over one or more years or growing seasons. The quantity of the agricultural commodity subject to the commitment may be agreed upon by a contracting entity and the agricultural producer. The period and quantity of the commitment may influence the amount of the payment made by the producer, and the effective discount on the price of the inputs.

In the case of agricultural equipment, the delivered equipment may be sold, rented, or leased to the agricultural producer. Accordingly, the agricultural producer may take title in the delivered equipment, or title may remain in the contracting entity or a third party. The contracting entity may be an agricultural commodities trader, an operator of a grain elevator, an equipment seller or manufacturer, or any other party having a financial interest in the trading of agricultural commodities or sales of agricultural equipment, non-equipment agricultural inputs, and/or non-agricultural input.

Examples of agricultural commodities include, but are not limited to, grains, oilseeds, fruit, vegetables, cotton, livestock, and livestock byproducts. Examples of agricultural equipment include, but are not limited to, irrigation equipment, planting equipment, harvesting equipment, livestock shelters, livestock feeders, drying equipment, and storage facilities. Examples of non-equipment agricultural inputs include, but are not limited to, seed, feed, pharmaceuticals, fertilizer, pre-emergent herbicide, post-emergent herbicide, and insecticide. Examples of non-agricultural inputs include, but are not limited to, airline tickets, vacation packages, coupons, and financial contributions to health investment accounts, such as a health savings account (HSA) and a flex spending account (FSA), or retirement investment accounts, such as an individual retirement account (IRA).

In some cases, the agricultural transaction may involve a commitment to deliver a combination of different types and quantities of agricultural commodities, as well as a combination of different types and quantities of inputs, e.g., agricultural equipment, non-equipment agricultural inputs, and non-agricultural inputs. The inputs may be exchanged in consideration of a commitment by the agricultural producer to deliver a specified quantity of an agricultural commodity over a specified period of time and, in some cases, a payment from the agricultural producer.

In one embodiment, the invention provides a method comprising selecting a type of agricultural commodity, selecting a number of one or more periods for delivery of the agricultural commodity from a producer of the agricultural commodity to a recipient, selecting a quantity of the agricultural commodity to be delivered during each of the periods, selecting a target price for the agricultural commodity for each of the periods, selecting a type of non-agricultural input, and establishing an amount to be paid by the producer based on one or more of the selections.

In another embodiment, the invention provides computer-implemented method comprising receiving user input specifying a selected type of agricultural commodity, a selected number of one or more periods for delivery of the agricultural commodity from a producer of the agricultural commodity to a recipient, a selected quantity of the agricultural commodity to be delivered during each of the periods, a selected target price for the agricultural commodity for each of the periods, and a selected type of non-agricultural input, computing an amount to be paid by the producer based on one or more of the selections, and, if the amount is not acceptable to the producer, adjusting the user input, and recomputing the amount.

In an additional embodiment, the invention provides a computer-implemented system comprising a commodity pricing module that obtains user input specifying a selected type of agricultural commodity, and a selected target price for the agricultural commodity for each of one or more periods for delivery of the agricultural commodity, an equipment pricing module that obtains a selected type of non-agricultural input, and pricing information for the non-agricultural input, and a transaction module that obtains a selected number of one or more periods for delivery of the agricultural commodity from a producer of the agricultural commodity to a recipient, and a selected quantity of the agricultural commodity to be delivered during each of the periods, and computes an amount to be paid by the producer based on the selections.

In a further embodiment, the invention provides a method comprising selecting a type of commodity, selecting a number of one or more periods for delivery of the commodity from a producer of the commodity to a recipient, selecting a quantity of the commodity to be delivered during each of the periods, selecting a target price for the commodity for each of the periods, selecting a type of input, and establishing an amount to be paid by the producer based on one or more of the selections.

Some aspects of the invention may be embodied as a computer-readable medium comprising instructions for causing a programmable processor to perform procedures in support of the methods described in this disclosure. Accordingly, the invention may be implemented, at least in part, by a computer.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 is a diagram illustrating interaction between an agricultural producer and a contracting entity in support of a transaction in accordance with an embodiment of the invention.

FIG. 2 is a diagram illustrating interaction between an agricultural producer, a contracting entity, an agricultural commodity recipient, and an equipment supplier in support of a transaction in accordance with another embodiment of the invention.

FIG. 3 is a diagram illustrating interaction between an agricultural producer, a contracting entity, an agricultural commodity recipient, and an input administrator in support of a transaction in accordance with another embodiment of the invention.

FIG. 4 is a diagram illustrating interaction between an agricultural producer, an agricultural agent, a contracting entity, an agricultural commodity recipient, and an input administrator in support of a transaction in accordance with another embodiment of the invention.

FIG. 5 is a flow diagram illustrating establishment of the terms of a transaction in accordance with an embodiment of the invention.

FIG. 6 is a block diagram illustrating a computing system for formulating the details of a transaction in accordance with an embodiment of the invention.

### DETAILED DESCRIPTION

A preferred embodiment of the invention is directed to methods for performing agricultural transactions by which a contracting entity provides an agricultural producer with inputs in exchange for a commitment from the agricultural producer to deliver a specified quantity of an agricultural commodity over a period, e.g., within one or more years, and, in some cases, a payment. For example, inputs may include agricultural equipment, non-equipment agricultural inputs, and non-agricultural inputs. In effect, the commitment and the payment may result in a discount, i.e., reduced cost or potentially no cost, for delivery of the input. The contracting entity may be a grain trader, grain elevator, equipment seller or manufacturer, or any other party having a financial interest in trading of grain or sales of agricultural equipment, non-equipment agricultural inputs, and non-agricultural inputs.

As one example, the agricultural producer may agree with the contracting entity to deliver a quantity of grain to a specified recipient in exchange for delivery of agricultural equipment in the form of a storage facility, such as a grain storage bin, at a reduced price. Other examples of agricultural equipment include irrigation equipment, planting equipment, livestock shelters, livestock feeders, harvesting equipment such as tractors, trucks, trailers and the like, and drying equipment.

In some embodiments, the agricultural producer may receive non-equipment agricultural inputs in lieu of, or in combination with, agricultural equipment. The non-equipment agricultural inputs may be any inputs useful by the agricultural producer in production of agricultural commodities, including agricultural commodities specified as part of the delivery commitment. Examples of non-equipment agricultural inputs include seed, feed, pharmaceuticals, fertilizer, pre-emergent herbicide, post-emergent herbicide, and insecticide.

In other embodiments, the agricultural producer may receive non-agricultural inputs in lieu of, or in combination with, agricultural equipment and non-equipment agricultural inputs. The non-agricultural inputs may be any inputs useful by the agricultural producer in non-agricultural aspects of production of agricultural commodities. Examples of non-agricultural inputs include airline tickets, vacation packages, coupons, and contributions to health investment accounts, such as a health savings account (HSA) and a flex spending account (FSA), or retirement investment accounts, such as an individual retirement account (IRA). The contracting entity may provide the non-agricultural inputs to one or more of the agricultural producer, family members of the producer, and employees of the producer.

Enacted by the U.S. federal government in 2003, an HSA allows a person to purchase a high-deductible health insurance plan and place a tax-deductible contribution of up to a maximum contribution level, e.g., $5,250, per year in an account that can be used to cover copays, pharmacy bills, deductibles and other health related expenses. The maximum contribution level of an HSA may be adjusted annually based on a federally set cost of living adjustment. Any funds remaining in the HSA at year-end can be carried over for expenses in subsequent years. Until used for medical expenses, the funds grow according to investment choices made by the participant. In many cases, the HSA administrator is a bank and the return is a fixed interest rate. In accordance with this disclosure, the contribution can be made by a different entity, e.g., in exchange for a commitment to deliver a quantity of an agricultural product. In some cases, a contracting entity may provide an agricultural producer with up to 100% funding of the HSA from day one of each tax year. Thus, the agricultural producer obtains affordable health care coverage.

The specified recipient of the agricultural products may be the contracting entity or some other entity. The contracting entity may be the physical recipient of the grain, but this is not necessary. Rather, the contracting entity may direct the agricultural producer to deliver the grain to a third party recipient specified by the contracting entity. In addition, the contracting entity may provide the agricultural producer with delivery of or access to at least one of the agricultural equipment, non-equipment agricultural input, and non-agricultural inputs. Alternatively, the contracting entity may identify a third party provider from whom the agricultural producer picks up or takes delivery of the input.

In some embodiments, the agricultural equipment may be branded to indicate the identity of the contracting entity or some other entity, e.g., for advertising purposes on the producer's farm. In other embodiments, components of the non-agricultural input, such as debit cards that enable automatic withdrawal of money from a health savings account at the time of the transaction, may be branded to indicate the identity of the contracting entity or some other entity, e.g., for advertising purposes in health clinics, pharmacies, and drug stores.

As further transaction features, the contracting entity and the agricultural producer agree to a particular price for the quantity of the agricultural commodity to be delivered by the agricultural producer and, in some cases, a payment. The payment may be an up-front payment or a payment made under a periodic payment plan. Together, the commitment and the payment result in a reduced price, or no price, for delivery of the inputs, e.g., agricultural equipment, non-equipment agricultural input, or non-agricultural input. In addition, the transaction may apply to a period, e.g., a single growing season, multiple growing seasons, or other specified periods of time.

As an example, the price of the committed quantity of agricultural commodity may be based on a formula that specifies that the price will be no greater than a specified target futures price on a particular date, adjusted for basis. The target futures price is a futures price quoted by a relevant market, exchange, or board of trade. If, on a specified date, the closing settlement price of the corresponding futures price is at or above the target futures price, the producer will receive the target futures price, adjusted for basis.

If the closing settlement price is below the target futures price on that day, however, the agricultural commodity is then priced at the prevailing market price on a mutually agreed upon date, or a date chosen by the producer within a date range specified by the producer and the contracting entity. Typically, the date for determination of the prevailing market price may be any time prior to delivery of the agricultural commodity, but may extend beyond delivery, or may be required at an earlier date.

In one embodiment, the target futures price serves as a futures reference price that determines the maximum price to be paid by the contracting entity. Again, the target futures price, adjusted for basis, is paid if the closing settlement price for the corresponding futures is at or above the target futures price. Otherwise, the applicable price is the prevailing market price. In some cases, if the producer set a price later because the target is not achieved, it is possible that he could obtain a higher price than the target.

As another example, the price of the committed quantity of agricultural commodity may be based on a formula that specifies that the price will be no less than a specified target futures price on a particular date, adjusted for basis. If, on a specified date, the closing settlement price of the corresponding futures is at or below the target futures price, the producer will receive the target futures price, adjusted for basis. If the closing settlement price is above the target futures price on that day, however, the agricultural commodity is then priced at the prevailing market price on a mutually agreed upon date, or a date chosen by the producer within a date range specified by the producer and the contracting entity.

In one embodiment, the target futures price serves as a futures reference price that determines the minimum price to be paid by the contracting entity. Again, the target futures price, adjusted for basis, is paid if the closing settlement price for the corresponding futures is at or below the target futures price. Otherwise, the applicable price is the prevailing market price. In some cases, if the producer set a price later because the target is not achieved, it is possible that he could obtain a lower price than the target.

The agricultural producer may agree to deliver the same or different quantities of the agricultural commodity in different contract periods, such as different growing years, in the event the transaction contemplates multiple periods. In some instances, different target futures prices may be used for different periods, although they may reference the same futures price for each year, e.g., March futures at the Chicago Board of Trade on a given date.

In each case, the target futures price, adjusted for basis, serves as either the maximum price or the minimum price to be paid to the agricultural producer for the specified quantity of agricultural commodity. The prices may be paid by the contracting entity or a third party recipient, if applicable. In some cases, the target price may be a price that is not yet established, such as a price that is a certain amount above or below a futures price on a date specified in the future. Accordingly, the target futures price may be a function of a price yet to be observed.

In effect, the inputs, e. g., agricultural equipment, non-equipment agricultural inputs, and/or non-agricultural inputs, may be provided to the agricultural producer at a reduced price that is a function of the quantity of agricultural commodity to be delivered by the agricultural producer, the number of periods applicable to the transaction, the target futures price level agreed upon by the contracting entity and the agricultural producer, the characteristics of the inputs, the payment to be made by the producer, or other factors.

In some cases, the agricultural producer may first indicate a desired payment to be made, and then negotiate toward a specified quantity, number of one or more periods, and target futures price level sufficient to support delivery of the inputs given the payment amount. In other cases, the process may work in reverse, i.e., the specified quantity, number of periods, and target futures price level may be determined first.

In either case, the contracting entity and the agricultural producer negotiate a number of inter-related transaction points, which yield a price to be paid for the agricultural equipment, the non-equipment agricultural inputs, and/or the non-agricultural inputs. Software may be provided to automate the negotiation process based on a pre-established relationship among the inter-related transaction points, as will be described. In some embodiments, different fixed combinations of transaction points, e.g., specified quantity, number of periods, target futures price level, input type, and payment, may be pre-established for selection by the contracting entity and the agricultural producer.

The result of the negotiation will be a transaction that specifies a quantity or quantities of the agricultural commodity for one or more periods, a target futures price for one or more periods, a number of periods applicable to the transaction, and a payment to be made to the contracting entity by the agricultural producer. In exchange, the contracting entity agrees to pay the producer for the commodity and arrange delivery of the input. For purposes of illustration, this description refers to calendar years as an example of applicable contract periods.

The quantity and target futures price may be specified to be different for successive years of the transaction. In some embodiments, the quantity, target futures price level, and number of years may be such that the agricultural producer, in effect, pays a drastically reduced price for the inputs, or even a zero price. In some cases, terms may be set such that the producer pays a negative price. In other words, the producer may actually receive a payment from the contracting entity, e.g., in the form of a cash payment or rebate from the contracting entity, in addition to the input.

As an example, the contracting entity may be responsible for payment of the difference between a regular price and the effective discounted price to an equipment supplier from whom the producer takes delivery of agricultural equipment. In this case, the agricultural provider makes a payment to the contracting entity or the equipment supplier, with the contracting entity making up the difference between the producer's payment and the full price. Alternatively, the contracting entity receives the payment directly from the agricultural producer, and the contracting entity is then responsible for payment of the full price of the equipment to the equipment manufacturer.

As another example, the contracting entity may be responsible for making contributions to an input administrator, such as a health or retirement investment account administrator, from whom the producer takes delivery of the non-agricultural input. In this case, the contracting entity makes contributions that are less than or equal to annual maximum contribution levels of the investment accounts on behalf of the producer. If the contributions are less than the annual maximum contribution levels, the agricultural provider may make additional contributions to the input administrator for the investment accounts.

In support of the transaction, as an illustration, the contracting entity and the agricultural producer set a Pricing Date, a Futures Reference Month, a Target Futures Price, a Quantity, and one or more Shipment Periods. Each Shipment Period may be one year in a multi-year commitment. The Pricing Date is the date during each Shipment Period that the Target Futures Price is set. The Target Futures Price is set according the futures price for a selective month, the Futures Reference Month. For each Shipment Period, if on the Pricing Date, the Futures Reference Month closing settlement price is equal to or higher than the Target Futures Price, the Futures Reference Price for the Quantity to be delivered in such Shipment Period will be the Target Futures Price.

If the Futures Reference Month closing settlement price is lower than the Target Futures Price on the Pricing Date, however, the Futures Reference Price for the Quantity to be delivered in such Shipment Period may be established by using marketing alternatives offered by the contracting entity, or other buyer, at the delivery location on a date selected by the Seller. The selected date will not be later than the last business day before the first day of the Futures Reference Month. If the agricultural producer fails to establish the Futures Reference Price, then the contracting entity may have the right to establish the Futures Reference Price.

In other embodiments, for each Shipment Period, if on the Pricing Date, the Futures Reference Month closing settlement price is equal to or lower than the Target Futures Price, the Futures Reference Price for the Quantity to be delivered in such Shipment Period will be the Target Futures Price. If the Futures Reference Month closing settlement price is higher than the Target Futures Price on the Pricing Date, however, the Futures Reference Price for the Quantity to be delivered in such Shipment Period may be established by using marketing alternatives offered by the contracting entity, or other buyer, at the delivery location on a date selected by the Seller.

The basis may be set using basis quotes obtained by the agricultural producer at the delivery location for the commodity during the Shipment Period on or before the earlier of (a) the first date of delivery during the Shipment Period or (b) the last business day before the first day of the Futures Reference Month. If the agricultural producer fails to set the basis, the contracting entity may have the right to set the basis.

As an example of a transaction in accordance with an embodiment of the invention, assume that an agricultural producer commits to deliver 50,000 bushels of March delivery no. 2 type corn for each of three consecutive years. Each year, the 50,000 bushel delivery commitment is priced at a target futures price that is compared to an applicable futures price, such as March futures. In this example, assume March futures for corn is selected, and that the March target futures price is $2.50, adjusted for basis.

If, on an agreed upon date, e.g., January 2 of that year, the daily closing settlement price of March futures is at or above the target futures price of $2.50, then the agricultural producer is paid $2.50 per bushel by the contracting entity or some other specified recipient. Hence, the $2.50 target futures price level serves as a maximum price for delivery of the specified quantity.

If March futures are below the target futures price of $2.50 on that day, however, the grain is priced at the prevailing market price sometime prior to delivery. Consequently, it is possible that the agricultural producer may receive less than the target futures price level of $2.50 which, again, serves as a maximum price of the quantity of grain to be delivered by the agricultural producer.

According to this example, in exchange for the firm delivery commitment of the specified quantity, the producer receives a 50,000 bushel grain bin for $5,000. In this example, assume that the cost of the grain bin would typically be $20,000 if purchased by the agricultural producer through traditional retail channels. Thus, in effect, the agricultural producer receives a substantial discount on the purchase of the grain bin in exchange for a commitment to deliver 50,000 bushels of grain for each of three consecutive years at a maximum price determined according to comparison of the target futures price and the March futures on the settlement date for the applicable year. In some embodiments, rather than physical delivery, a cash swap is possible if the agricultural producer is a swap-eligible entity.

In the case of agricultural equipment, the agricultural equipment may be delivered to the agricultural producer by the contracting entity or by a third party supplier specified by the contacting entity. Alternatively, the agricultural producer may be responsible for transportation and any construction or installation that may be necessary for the agricultural equipment. For example, the agricultural producer may be responsible for picking up the equipment at a warehouse, manufacturing site, or distribution or outlet of the equipment manufacturer. In the case of agricultural inputs, the producer may be responsible for delivery charges or pickup at the location of a retailer of the agricultural inputs.

In the case of non-agricultural inputs, the non-agricultural inputs may be delivered to the agricultural producer by the contracting entity or by a third party administrator specified by the contacting entity. The contracting entity may be responsible for establishing a HSA, for example, on behalf of the producer, family members of the producer, and/or employees of the producer. In addition to making contributions to the HSA, the contracting entity may also be responsible for any administrative fees associated with maintaining the HSA. Alternatively, the agricultural producer may be responsible for establishing a health or retirement investment account with an investment account administrator to which the contracting entity can contribute. Furthermore, the agricultural producer may be responsible for picking up airline tickets or vacation packages from the contracting entity or the third party administrator, e.g., a travel agent.

In addition to the transaction between the contracting entity and the agricultural producer, there may be additional agreements for transactions between the contracting entity and third parties. For example, the contracting entity may commit to delivery of all or some of the specified quantity of agricultural commodity to one or more specified recipients, with delivery being made either directly from the agricultural producer or via the contracting entity or its agents. In addition, the contracting entity may enter into an agreement with an equipment manufacturer or retailer for delivery or pickup of the equipment to or by the agricultural producer, and payment of the difference between the regular price and the discounted price for the equipment. A similar arrangement may be made between the contracting entity and suppliers or retailers of non-equipment agricultural inputs, and administrators of non-agricultural inputs.

In other cases, the contracting entity may be a vertically oriented agricultural company with the capability to receive the agricultural commodity and provide the input directly to the agricultural producer, such that there is no need for third party involvement. In some embodiments, on the contrary, the contracting entity may simply be poised as a trader of agricultural commodities, and execute the transaction with the agricultural producer to support its trading endeavors and relationships with third parties such as recipients of the agricultural commodity, the equipment supplier, the non-equipment agricultural input supplier, and the non-agricultural input administrator.

In some embodiments, the agricultural producer will benefit from the ability to obtain agricultural equipment at a reduced cost, reducing cash outlay when acquiring the equipment. Also, in some embodiments, the producer may be given a choice of a wide array of different types of equipment or different equipment models, and select more than one type of equipment in a given year. In addition, if the agricultural equipment is storage equipment, such as a grain storage bin, the invention provides the producer with a convenient on-site storage method for the product to be delivered pursuant to the quantity commitment.

The contracting entity provides an obligation to purchase the specified quantity of agricultural commodity, either directly or via a third party recipient. This feature provides the agricultural producer with a disciplined marketing plan on a portion of its output product. Notably, the transaction may apply to multiple years, contemplate different quantities, and pertain to different types of agricultural equipment, which may qualify as depreciable capital equipment under applicable tax and accounting regulations, non-equipment agricultural inputs, and non-agricultural inputs, which may qualify as tax-advantaged health or retirement investment accounts.

In addition, if the agricultural equipment is storage equipment, such as a grain storage bin, the invention provides the producer with a convenient on-site storage method for the product to be delivered pursuant to the quantity commitment.

The invention may be adapted to apply to producers of non-agricultural commodities, such as oil, gold, silver, iron, or other metals, minerals and the like. For example, non-agricultural commodity producers such as oil companies, mining companies, and the like may enter into transactions for exchange of equipment or non-equipment inputs at a discounted price in consideration of a commitment to deliver a specified quantity of a non-agricultural commodity over a specified period of time.

Examples of equipment delivered to non-agricultural commodity producers include any equipment useful in producing the pertinent commodity or commodities, including capital equipment such as storage facilities, drilling equipment, mining equipment, processing equipment, exploration equipment, and tractors, trucks, trailers and the like. Examples of non-equipment inputs delivered to non-agricultural commodity producers include any non-equipment inputs useful in producing the pertinent commodity or commodities, including raw materials, such as fossil fuels and processing materials, and other inputs, such as airline tickets, vacation packages, coupons, and contributions to health or retirement investment accounts for the producers, family members of the producers, or employees of the producers.

In exchange for a discount on sale or contribution levels of such inputs, the non-agricultural commodity provider agrees to deliver an agreed upon quantity over an agreed upon period of time. Hence, the invention may be readily applicable to the exchange of non-agricultural commodities without substantial modification.

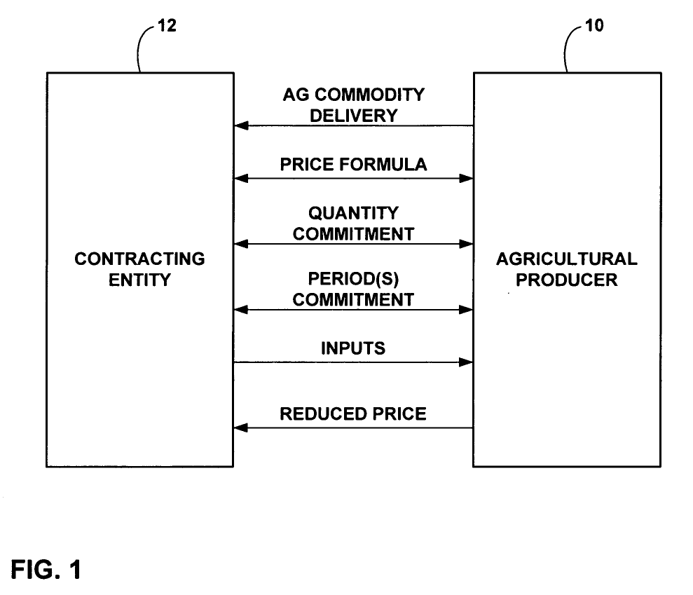

FIG. 1 is a diagram illustrating interaction between an agricultural producer 10 and a contracting entity 12 in support of a transaction in accordance with an embodiment of the invention. As shown in FIG. 1, the contracting entity 12 and agricultural producer 10 agree to a price formula based on a target futures price level, e.g., March futures, a quantity commitment, and a number of years applicable to the transaction. The agricultural producer 10 then delivers the committed quantity of an agricultural commodity to the contracting entity 12.

The contracting entity 12 then arranges delivery of inputs, such as agricultural equipment, non-equipment agricultural inputs, and non-agricultural inputs, to the agricultural producer 10, and the agricultural producer pays a reduced price for the input. The contracting entity 12 may obtain the input from a third party supplier or administrator, or direct a third party to deliver the input. Alternatively, in some cases, contracting entity 12 may be a manufacturer, seller, supplier or administrator of the inputs.

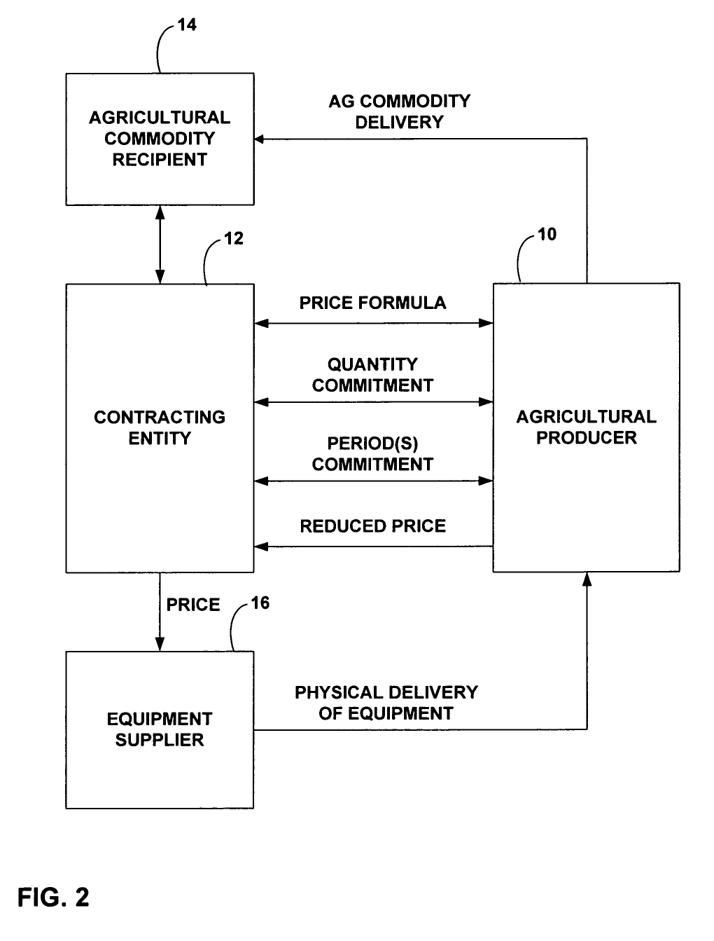

FIG. 2 is a diagram illustrating interaction between an agricultural producer 10, a contracting entity 12, an agricultural commodity recipient 14, and an equipment manufacturer or distributor 16 (hereafter “equipment supplier 16”) in support of a transaction in accordance with another embodiment of the invention. The process illustrated in FIG. 2 is similar to that of FIG. 1, but further contemplates involvement of an agricultural commodity recipient 14 and an equipment supplier 16. In particular, the agricultural producer 10 delivers the commodity to a recipient 14 specified by the contracting entity 12, rather than to the contracting entity.

The contracting entity 12 and recipient 14 may have a contract in place with respect to the delivery. In addition, the agricultural producer 10 may receive equipment from the equipment supplier 16, rather than from contracting entity 12. In this case, the agricultural producer 10 may pay the discounted price to the equipment supplier 16, and the contracting entity 12 may pay the price difference to the equipment manufacturer supplier, i.e., the price difference between the regular price and the reduced price paid by the producer. Alternatively, as shown in FIG. 2, the agricultural producer 10 pays the reduced price to the contracting entity 12, and the contracting entity 12 pays the full price to the equipment supplier 16.

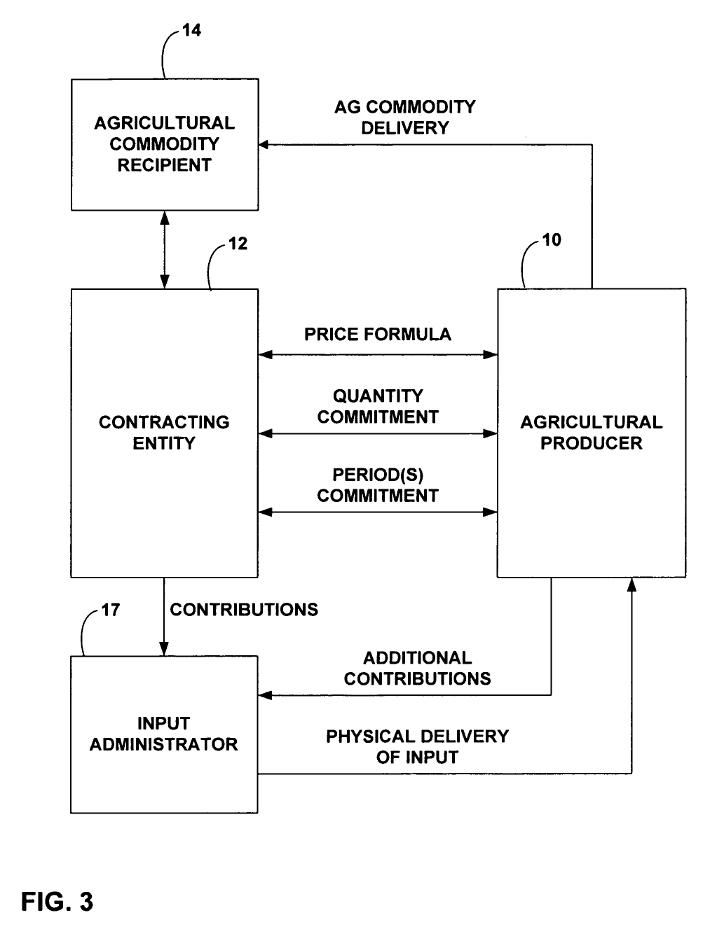

FIG. 3 is a diagram illustrating interaction between an agricultural producer 10, a contracting entity 12, an agricultural commodity recipient 14, and an input administrator 17 in support of a transaction in accordance with another embodiment of the invention. The process illustrated in FIG. 3 is similar to that of FIG. 1, but further contemplates involvement of an agricultural commodity recipient 14 and an input administrator 17. In particular, the agricultural producer 10 delivers the commodity to a recipient 14 specified by the contracting entity 12, rather than to the contracting entity.

The contracting entity 12 and recipient 14 may have a contract in place with respect to the delivery. In addition, the agricultural producer 10 may receive non-agricultural input from the input administrator 17, rather than from contracting entity 12. For example, contracting entity 12 may be responsible for establishing an HSA with input administrator 17 on behalf of agricultural producer 10, family members of producer 10, and/or employees of producer 10. The HSA may qualify as a tax-advantaged health investment account for use by agricultural producer 10 to pay qualified medical expenses. In order to establish the HSA on behalf of agricultural producer 10, agricultural producer 10 may need to be enrolled in a high deductible health plan, depending on applicable regulations.

Contracting entity 12 makes contributions to input administrator 17 for the HSA that are less than or equal to an annual maximum contribution level of the HSA. If the contributions by contracting entity 12 are less than the annual maximum contribution level, agricultural provider 10 may make additional contributions to the HSA. In addition to making contributions to the HSA, contracting entity 12 may also be responsible for any administrative fees associated with maintaining the HSA.

Agricultural producer 10 may select whether contracting entity 12 is to make the contributions to the HSA as a single deposit to input administrator 17 or as multiple deposits to input administrator 17. In addition, agricultural producer 10 may select one or more specific dates for deposit of the contributions from contracting entity 12 to the HSA. The contributions may be deposited at the time the contract is generated, at the time of delivery of the agricultural commodity, or at any other time specified by agricultural producer 10. For example, agricultural producer 10 may choose to deliver the agricultural commodity to the recipient 14 in October, but delay the contribution deposit until January of the next year.

Alternatively, agricultural producer 10 may be responsible for establishing a health or retirement investment account with input administrator 17 to which contracting entity 12 can contribute. Furthermore, agricultural producer 10 may be responsible for picking up airline tickets or vacation packages from contracting entity 12 or input administrator 17, which may be a travel agent.

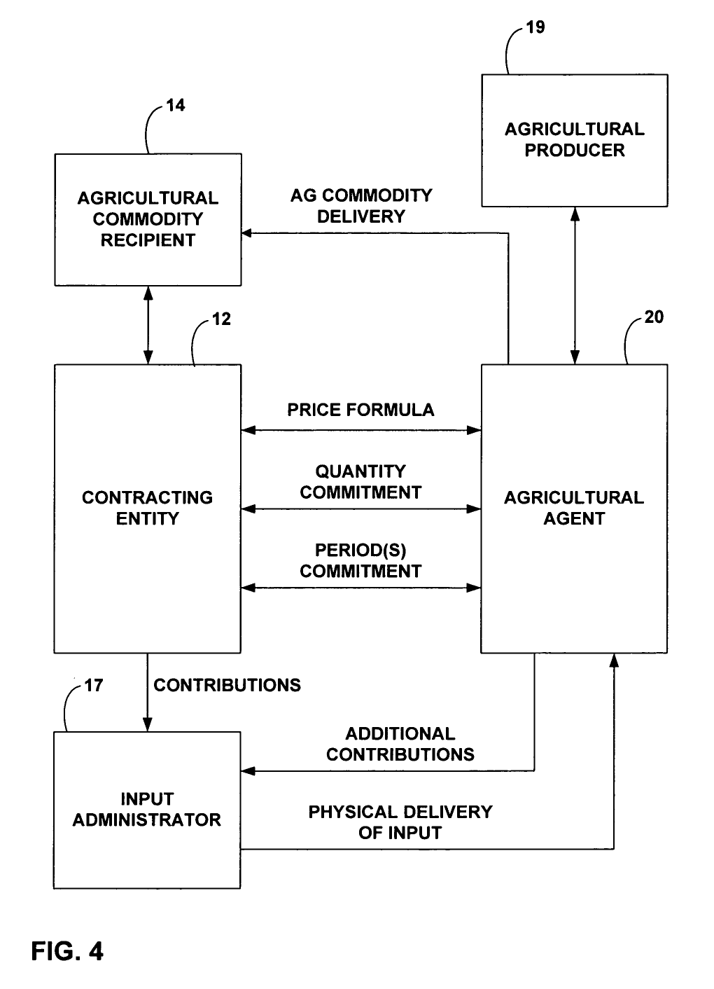

FIG. 4 is a diagram illustrating interaction between an agricultural producer 19, an agricultural agent 20, a contracting entity 12, an agricultural commodity recipient 14, and an input administrator 17 in support of a transaction in accordance with another embodiment of the invention. The process illustrated in FIG. 4 is similar to that of FIG. 3, but further contemplates involvement of an agricultural agent 20. In particular, the agricultural producer 19 delivers the commodity to an agricultural agent 20, rather than to the recipient 14. Agricultural agent 20, in turn, delivers the commodity to the recipient 14 specified by the contracting entity 12. Agricultural agent 20 may be a grain trader, grain elevator, or any other party having a financial interest in trading of grain or other agricultural commodities.

The contracting entity 12 and recipient 14 may have a contract in place with respect to the delivery. In addition, the agricultural agent 20, rather then agricultural producer 19, may receive non-agricultural input from the input administrator 17. For example, contracting entity 12 may be responsible for establishing an HSA with input administrator 17 on behalf of agricultural agent 20, family members of agent 20, and/or employees of agent 20. The HSA may qualify as a tax-advantaged health investment account for use by agricultural agent 20 to pay qualified medical expenses. In order to establish the HSA on behalf of agricultural agent 20, agricultural agent 20 may need to be enrolled in a high deductible health plan.

Contracting entity 12 makes contributions to input administrator 17 for the HSA that are less than or equal to an annual maximum contribution level of the HSA. If the contributions by contracting entity 12 are less than the annual maximum contribution level, agricultural agent 20 may make additional contributions to the HSA. In addition to making contributions to the HSA, contracting entity 12 may also be responsible for any administrative fees associated with maintaining the HSA.

Agricultural agent 20 may select whether contracting entity 12 is to make the contributions to the HSA as a single deposit to input administrator 17 or as multiple deposits to input administrator 17. In addition, agricultural agent 20 may select one or more specific dates for deposit of the contributions from contracting entity 12 to the HSA. The contributions may be deposited at the time the contract is generated, at the time of delivery of the agricultural commodity, or at any other time specified by agricultural agent 20.

Alternatively, agricultural agent 20 may be responsible for establishing a health or retirement investment account with input administrator 17 to which contracting entity 12 can contribute. Furthermore, agricultural agent 20 may be responsible for picking up airline tickets or vacation packages from contracting entity 12 or input administrator 17, which may be a travel agent.

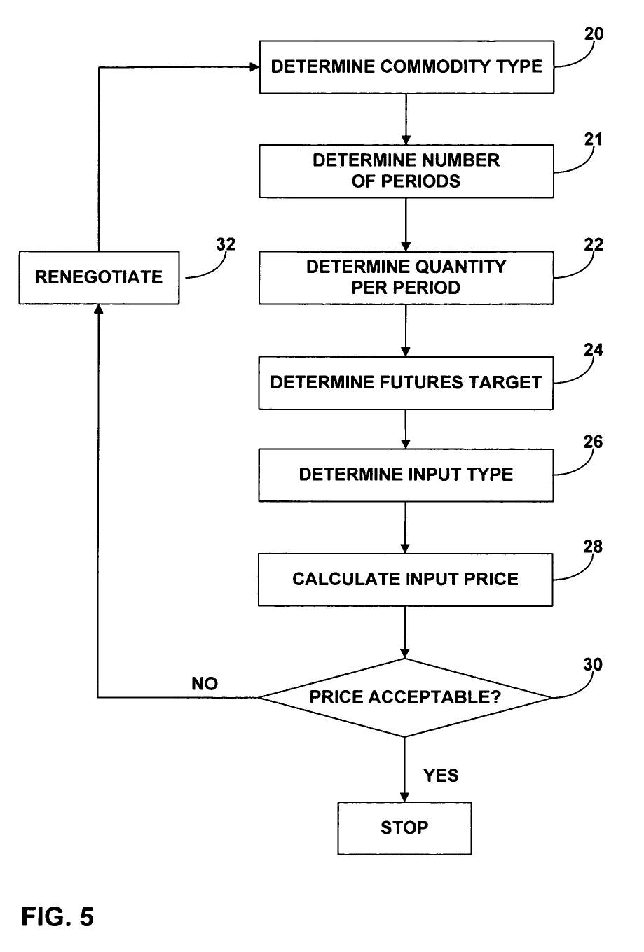

FIG. 5 is a flow diagram illustrating establishment of the terms of a transaction in accordance with an embodiment of the invention. As shown in FIG. 5, the contracting entity 12 and agricultural producer 10 determine the agricultural commodity type (18), the number of periods (20) for which the commodity will be delivered, the quantity of the commodity to be delivered per period (22), a target futures price level (24) for the commodity, and the type of input to be provided to the producer (26).

In the case of agricultural equipment or non-equipment agricultural inputs, based on those determinations, the contracting entity 12 calculates the reduced input price (28) to be paid by the agricultural producer 10. If the price is not acceptable (30), e.g., if the agricultural producer 10 would like to pay less for agricultural equipment or non-equipment agricultural inputs, the contracting entity and the producer may renegotiate (32) any or all of the transaction features, such as commodity type, number of periods, quantity, futures target and input type.

In the case of non-agricultural inputs, such as HSA contributions, based on the above determinations, the contracting entity 12 calculates an input price, e.g., a contribution amount, (28) to be paid by the contracting entity 12. If the price is not acceptable (30), e.g., if the agricultural producer 10 would like to receive a larger contribution amount for non-agricultural inputs, the contracting entity and the producer may renegotiate (32) any or all of the transaction features, such as commodity type, number of periods, quantity, futures target and input type. This process may continue in an iterative manner until all of the transaction features, including the input price, are acceptable to both parties.

In the example of FIG. 5, the input price is calculated after an initial determination of the other transaction features. As an alternative, the process may work in reverse, with the producer 10 first specifying the price he wants to pay for agricultural equipment or non-equipment agricultural inputs, or the contribution amount he wants paid by contracting entity 12 for non-agricultural inputs. Notably, if transaction features are sufficiently favorable to the contracting entity 12, the agricultural equipment price may be drastically reduced, in some cases reduced to zero, and the non-agricultural input contribution amount may be drastically increased, in some cases increased to a maximum contribution amount.

It is noted that the flow diagram of FIG. 5 also represents a process that can be readily modified to be applicable to the exchange of non-agricultural inputs in lieu of, or in combination with, non-agricultural equipment, in the case of transactions involving non-agricultural commodities.

Set forth below in Table 1 is an example of different negotiation scenarios leading to a discounted agricultural equipment price.

TABLE 1

| | Scenario 1 | Scenario 2 | Scenario 3 | Scenario 4 |
|---|---|---|---|---|
| Bushels | 20,000 | 30,000 | 20,000 | 50,000 |
| Years | 2 | 3 | 3 | 3 |
| Type | No. 2 Corn | No. 1 Corn | No. 2 Corn | Soybeans |
| Max Price | $2.42 | $2.42 | $2.50 | $6.00 |
| Equipment | 25,000 | 25,000 | 25,000 | 25,000 |
| Type | bushel bin | bushel bin | bushel bin | bushel bin |
| Payment | $4,000 | $2,000 | $2,000 | $2,000 |

In Scenario 1 of Table 1 above, the producer agrees to deliver 20,000 bushels per year of No. 2 yellow corn for two years subject to a maximum price (based on target futures price level) of $2.42. Hence, the commodity type is No. 2 yellow corn, the period is two years, and the quantity is 20,000 bushels per year. In this case, the producer receives a 25,000 bushel bin regularly priced at $20,000 in exchange for a payment of $4,000 and the quantity commitment. The 25,000 bushel bin is the agricultural equipment type. Scenarios 2 and 3 represent changes to the specified quantity, year, price, and grain type. Scenario 4 represents a transaction involving soybeans rather than corn, i.e., a change in commodity type.

The term “agricultural producer” as used herein may refer to any producer of agricultural commodities, from an individual farmer or rancher to a large corporate farming operation. An “agricultural commodity” produced by the agricultural producer may take the form of crops such as grain, oilseeds, vegetables, fruit, cotton, and the like. Although the agricultural commodities discussed herein may center upon crops such as corn, the use of corn is simply an illustrative commodity. The invention is not limited to crops in general or to corn in particular. Rather, “agricultural commodity” also may include livestock or animal produce, as well as any byproducts of the foregoing products. Again, the invention also may be modified for use with other types of commodities, such as non-agricultural commodities, as discussed above.

As discussed previously, the term “agricultural equipment” may include any of a variety of equipment useful in agricultural production, including storage facilities such as grain storage bins, irrigation equipment, planting equipment, livestock shelters, livestock feeders, harvesting equipment such as tractors, trucks, trailers and the like, and drying equipment. In some embodiments, a transaction may involve exchange of non-equipment agricultural inputs in lieu of, or in combination with, agricultural equipment. The non-equipment agricultural inputs may be any inputs useful in agricultural productions, including seed, feed, pharmaceuticals, fertilizer, pre-emergent herbicide, post-emergent herbicide, and insecticide.

In further embodiments, a transaction may involve exchange of non-agricultural inputs in lieu of, or in combination with, agricultural equipment and non-equipment agricultural inputs. The non-agricultural inputs may be any inputs useful in non-agricultural aspects of agricultural production, including airline tickets, vacation packages, coupons, and contributions to health investment accounts, such as a HSA and a FSA, or retirement investment accounts, such as an IRA. Also, in some embodiments, the contracting entity and agricultural producer may agree that the transaction will involve delivery or pickup of more than one item of agricultural equipment, non-equipment agricultural inputs, and/or non-agricultural inputs.

For example, an agricultural producer may take delivery of multiple grain storage bins, either at the same time or over the course of a period of time, e.g., one or more bins per growing year. The payment made to the contracting entity by the producer also may be spread out over a period of time, if desired by the contracting entity and the agricultural producer. In addition, the agricultural producer may take delivery of different types of agricultural equipment, e.g., a grain storage bin in year 1, a truck in year 2, and another grain storage bin in year 3. In addition, with sufficient quantity and price commitments and other agreed upon transaction features, it is conceivable that the producer may take delivery of different types of equipment within a given year.

The payment made by the agricultural producer for the equipment may be made up-front upon agreement with the contracting entity or upon delivery or pickup of the equipment. Alternatively, as an option, the payment may be made in the form of a discount to the price paid by the contracting entity for the quantity of agricultural commodity delivered by the agricultural producer.

Certain aspects of the invention may be embodied as a computer-readable medium comprising instructions for causing one or more programmable processors to carry out procedures in support of the techniques described herein. For example, software may be provided to facilitate negotiation, selection, and determination of transaction features such as quantity, number of years, target futures price, and input pricing. In some embodiments, a web-based application may be used to enter transaction information and perform applicable calculations. Examples of computer-readable media to carry such instructions random access memory (RAM), read-only memory (ROM), non-volatile random access memory (NVRAM), electrically erasable programmable read-only memory (EEPROM), FLASH memory, magnetic data storage media, optical data storage media, or the like.

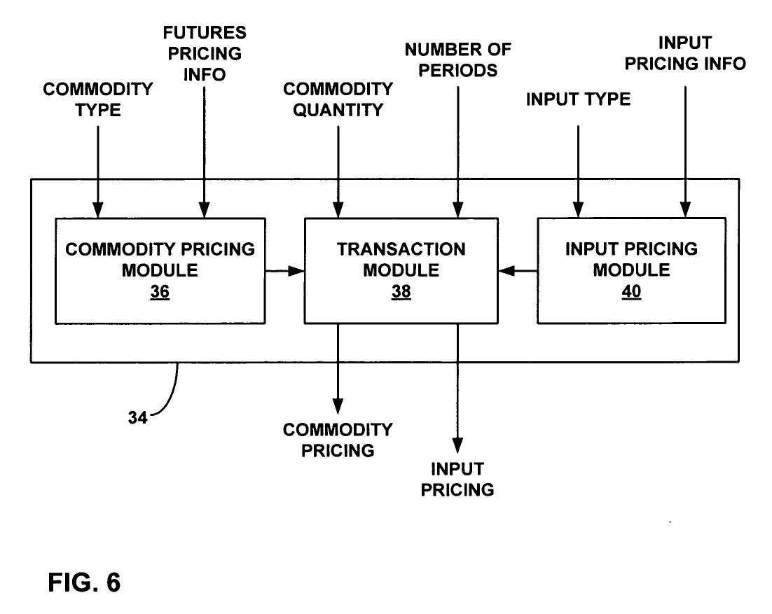

FIG. 6 is a block diagram illustrating a computing system 34 for formulating the details of a transaction in accordance with an embodiment of the invention. System 34 may be implemented using a general purpose processor, for example, in a desktop or notebook computer. In some embodiments, system 34 may include a local area, wide area, or global network connection to facilitate retrieval of information, such as commodity and input pricing information on a periodic or near real-time basis. As shown in FIG. 6, the functionality supported by system 34 may be implemented with a set of modules 36, 38, 40. The modules 36, 38, 40 may be software modules executable by a processor within system 34 to support the method described in this disclosure. Although modules 36, 38, 40 are illustrated for purposes of example, the architecture of system 34 may be subject to wide variation.

In the example of FIG. 6, system 34 includes commodity pricing module 36, a transaction module 38 and input pricing module 40. To formulate the points of a transaction, commodity pricing module 36 obtains commodity type information identifying the type of commodity to be exchanged pursuant to an agreement between an agricultural producer and a contracting entity. The commodity type information may be entered by a user. The commodity type may refer to a broad type of commodity, such as grain, corn, soybeans or the like, or a sub-category within a commodity type, such as No. 1 corn or No. 2 corn.

Using the commodity type information, commodity pricing module 36 obtains futures pricing information for the commodity for a relevant futures month. The futures pricing information may include a target futures price and reference month entered by a user into system 34. A remote server may provide updated futures pricing obtained from a relevant market, exchange, or board of trade, for review by the user to aid in selection of the target futures price. Alternatively, the futures pricing information may be locally stored within system 34, and updated periodically.

Commodity processing module 36 passes the pricing information to transaction module 38. Transaction module 38 obtains the commodity quantity from a user of system 34, as well as the number of periods over which the commodity will be delivered. Input pricing module 40 obtains the input type desired by the agricultural producer. The input type may be entered by a user of system 34. The input type may be selected from a variety of agricultural equipment types, non-equipment agricultural input types, and non-agricultural input types. Using the input type, input pricing module 40 accesses local storage or a remote server to obtain input pricing information. Input pricing information may comprise a price for a specific type of agricultural equipment or non-equipment agricultural input type, or a contribution amount to a specific type of non-agricultural input type. Input pricing module 40 passes the input pricing information to transaction module 38.

Using the commodity pricing information from commodity pricing module 36, the input pricing information from input pricing module 40, and the commodity quantity and number of periods, transaction module 38 calculates commodity pricing and input pricing. The commodity pricing and input pricing are determined based on the various inputs described immediately above, as well as any additional functions or weightings applied by the contracting entity to the inputs. If the commodity and input pricing is acceptable to the contracting entity and the agricultural producer, an agreement containing the pertinent transaction details is signed. If terms are not acceptable, other inputs such as commodity type, commodity quantity, number of periods, and input type can be adjusted for another iteration by transaction module 38. In other embodiments, modules 36, 38, 40 may be modified to support transactions involving non-agricultural commodities and associated equipment and/or non-equipment inputs.

Some embodiments of the invention may be modified for use with consumers of agricultural inputs. For example, an agricultural inputs consumer such an agricultural producer may agree to pay a minimum price for agricultural inputs in consideration of purchase of agricultural equipment at a reduced price or contributions of non-agricultural inputs. The agricultural inputs may include seed, fertilizer, pre-emergent herbicide, post-emergent herbicide, or insecticide, or feed and pharmaceuticals. In exchange for an agreement to pay a minimum price for a particular input over one or more periods, e.g., years, the contracting entity provides the consumer with agricultural equipment at a reduced price, including possibly zero price. In other cases, the contracting entity may provide the consumer with contributions of non-agricultural inputs, such as contributions to HSAs, FSAs, and IRAs, up to annual maximum contribution amounts for the investment accounts. In this case, a commitment to purchase agricultural inputs takes the place of a commitment to deliver an agricultural commodity. In other embodiments, a transaction may involve both a commitment to purchase agricultural inputs and a commitment to deliver an agricultural commodity in exchange for purchase of equipment at a reduced price or contributions of non-agricultural inputs.

The following example illustrates a scenario in which an embodiment of the invention is applied to a transaction involving corn as an agricultural commodity and a storage bin as agricultural equipment. In this scenario, the agricultural producer agrees to a four-year commitment of corn delivery. The corn is priced based upon a pricing formula involving target futures prices and pricing dates, as will be described below.

In this example, the agricultural producer commits to delivery of 50,000 bushels of March-delivered corn. The agricultural producer and the contracting entity establish a Target Futures Prices of $2.50 per bushel. The Target Futures Price is the maximum possible futures reference price to be paid to the agricultural producer. Each year of the four-year commitment, the 50,000 bushels will be priced at $2.50 if, on January 2 (Target Date) of the applicable year, the March (Futures Reference Month) futures close at or above $2.50. If the March futures are below $2.50 on January 2, the futures must be established by February 28 in this example. The agricultural producer establishes its basis at any time prior to delivery of the corn each year. In exchange for this contract commitment, and a payment of $6,000, the agricultural producer receives a 50,000 bushel grain storage bin. In other embodiments, as described above, the Target Futures Price may be a minimum possible futures reference price to be paid to the agricultural producer.

In this example, the bushel amount to be delivered annually may be specified to not exceed 25% of annual production for the agricultural producer. In addition, the committed bushel amount may correspond to the capacity of the grain storage bin to be delivered to the agricultural producer. The multi-year commitment may be subject to a minimum three-year commitment. In some cases, the agricultural producer may be permitted to select one of nine different storage bins, ranging in capacity from approximately 17,000 bushels to approximately 105,000 bushels.

The agricultural producer receives the selected storage bin free on board (FOB) at the factory of the storage bin manufacturer. The agricultural producer is responsible for the cost of delivery and installation of the bin and any additional bin features.

The following example illustrates a scenario in which an embodiment of the invention is applied to a transaction involving corn as an agricultural commodity and a HSA as non-agricultural input. In this scenario, the agricultural producer agrees to a four-year commitment of corn delivery. The corn is priced based upon a pricing formula involving target futures prices and pricing dates, as will be describe below.

In this example, the agricultural producer commits to delivery of 50,000 bushels of March-delivered corn. The agricultural producer and the contracting entity establish a Target Futures Prices of $2.50 per bushel. The Target Futures Price is the maximum possible futures reference price to be paid to the agricultural producer. The 50,000 bushels will be priced at $2.50 if, on January 2, (Target Date) of the applicable year, the March (Futures Reference Month) futures close at or above $2.50. If the March futures are below $2.50 on January 2, the futures must be established by February 28, in this example. The agricultural producer establishes its basis at any time prior to delivery of the corn each year. In exchange for this contract commitment, the contracting entity contributes $5,250 in the HSA on behalf of the agricultural producer. In other embodiments, as described above, the Target Futures Price may be a minimum possible futures reference price to be paid to the agricultural producer. In addition to the contribution to the HSA, the agricultural producer may receive other benefits including reduced or eliminated administration fees for the HSA.

Various embodiments of the invention have been described. Nevertheless, various modifications may be made without departing from the scope of the invention.

1. A method comprising:
selecting a type of agricultural commodity;
selecting a number of one or more periods for delivery of the agricultural commodity from a producer of the agricultural commodity to a recipient;
selecting a quantity of the agricultural commodity to be delivered during each of the periods;
selecting a target price for the agricultural commodity for each of the periods;
selecting a type of non-agricultural input; and
establishing an amount to be paid by the producer based on one or more of the selections.

2. The method of claim 1, wherein the target price is a target futures price quoted for the agricultural commodity.

3. The method of claim 1, further comprising:
determining if the price is acceptable to the producer;
if the price is not acceptable, making alternative selections of at least one of the type of agricultural commodity, the number of periods, the quantity, the target price, and the type of non-agricultural input; and
recalculating the price based on the alternative selections.

4. The method of claim 1, wherein the non-agricultural input includes at least one of airline tickets, vacation packages, coupons, contributions to health investment accounts, and contributions to retirement investment accounts.

5. The method of claim 1, wherein the non-agricultural input includes contributions by the recipient of the agricultural commodity to at least one of a health savings account (HSA), a flex spending account (FSA), and an individual retirement account (IRA).

6. The method of claim 5, wherein the contributions are made by the recipient on behalf of at least one of the producer of the agricultural commodity, family members of the producer, and employees of the producer.

7. The method of claim 5, wherein the contributions are made by the recipient on behalf of at least one of an agent of the agricultural commodity, family members of the agent, and employees of the agent, wherein the agent purchases the agricultural commodity from the producer of the agricultural commodity.

8. The method of claim 5, wherein the contributions are less than or equal to annual maximum contribution levels of at least one of the HSA, FSA, and IRA.

9. The method of claim 5, wherein the producer of the agricultural commodity selects a number of one or more deposits of the contributions from the recipient of the agricultural commodity to at least one of the HSA, FSA, and IRA.

10. The method of claim 5, wherein the producer of the agricultural commodity selects one or more dates for deposit of the contributions from the recipient of the agricultural commodity to at least one of the HSA, FSA, and IRA.

11. The method of claim 1, wherein the non-agricultural input includes contributions to a health savings account for use by the producer to pay qualified medical expenses.

12. The method of claim 1, wherein the producer of the agricultural commodity is enrolled in a high deductible health plan.

13. The method of claim 1, wherein the agricultural commodity includes at least one of grain, vegetables, fruit, cotton, and livestock.

14. The method of claim 1, wherein selecting a quantity of the agricultural commodity to be delivered during each of the periods includes selecting quantities for the periods, wherein each of the quantities is substantially identical.

15. The method of claim 1, wherein selecting a quantity of the agricultural commodity to be delivered during each of the periods includes selecting quantities for the periods, wherein one or more the quantities are different.

16. The method of claim 1, wherein the periods are years and the number of periods is greater than one.

17. The method of claim 1, wherein, if a futures price on a selected date is at or above the selected target price, paying the producer the target price for the agricultural commodity, and, if a futures price on a selected date is below the selected target price, paying the producer a market price for the agricultural commodity.

18. The method of claim 1, wherein, if a futures price on a selected date is at or below the selected target price, paying the producer the target price for the agricultural commodity, and, if a futures price on a selected date is above the selected target price, paying the producer a market price for the agricultural commodity.

19. The method of claim 1, further comprising reducing the target price in consideration of pricing information for the non-agricultural input.

20. The method of claim 19, wherein reducing the target price comprises reducing the target price in consideration of a contribution amount by the recipient to at least one of a health investment account and a retirement investment account on behalf of the producer of the agricultural commodity.

21. The method of claim 1, further comprising marking components of the non-agricultural input with a brand name identifying the recipient.

22. The method of claim 21, wherein marking the components of the non-agricultural input comprises marking a debit card associated with a health savings account with the brand name identifying the recipient, wherein the debit card enables automatic withdrawal of money from the health savings account at the time of the transaction

23. The method of claim 1, wherein selecting a number of one or more periods for delivery of the agricultural commodity comprises selecting the number of periods for delivery of the agricultural commodity from an agent of the agricultural commodity to a recipient, wherein the agent purchases the agricultural commodity from the producer of the agricultural commodity.

24. The method of claim 1, further comprising receiving the selected type of agricultural commodity, the selected number of periods, the selected quantity, the selected target price, and the selected type of non-agricultural input in a computer, and computing an amount to be paid by the producer based on the selections.

25. A computer-implemented method comprising:
receiving user input specifying a selected type of agricultural commodity, a selected number of one or more periods for delivery of the agricultural commodity from a producer of the agricultural commodity to a recipient, a selected quantity of the agricultural commodity to be delivered during each of the periods, a selected target price for the agricultural commodity for each of the periods, and a selected type of non-agricultural input;
computing an amount to be paid by the producer based on one or more of the selections; and
if the amount is not acceptable to the producer, adjusting the user input, and recomputing the amount.

26. The method of claim 25, wherein the target price is a target futures price quoted for the agricultural commodity.

27. The method of claim 25, wherein the non-agricultural input includes at least one of airline tickets, vacation packages, coupons, contributions to health investment accounts, and contributions to retirement investment accounts.

28. The method of claim 25, wherein the non-agricultural input includes contributions by the recipient of the agricultural commodity to at least one of a health savings account (HSA), a flex spending account (FSA), and an individual retirement account (IRA) on behalf of the producer of the agricultural commodity.

29. The method of claim 25, wherein the non-agricultural input includes contributions to a health savings account by the recipient of the agricultural commodity for use by the producer to pay qualified medical expenses.

30. The method of claim 25, wherein the agricultural commodity includes at least one of grain, vegetables, fruit, cotton, and livestock.

31. A computer-implemented system comprising:
a commodity pricing module that obtains user input specifying a selected type of agricultural commodity, and a selected target price for the agricultural commodity for each of one or more periods for delivery of the agricultural commodity;
an input pricing module that obtains a selected type of non-agricultural input, and pricing information for the non-agricultural input; and
a transaction module that obtains a selected number of one or more periods for delivery of the agricultural commodity from a producer of the agricultural commodity to a recipient, and a selected quantity of the agricultural commodity to be delivered during each of the periods, and computes an amount to be paid by the producer based on the selections.

32. The system of claim 31, wherein the target price is a target futures price quoted for the agricultural commodity.

33. The system of claim 31, wherein the non-agricultural input includes at least one of airline tickets, vacation packages, coupons, contributions to health investment accounts, and contributions to retirement investment accounts.

34. The system of claim 31, wherein the non-agricultural input includes contributions by the recipient of the agricultural commodity to at least one of a health savings account (HSA), a flex spending account (FSA), and an individual retirement account (IRA) on behalf of the producer of the agricultural commodity.

35. The system of claim 31, wherein the non-agricultural input includes contributions to a health savings account by the recipient of the agricultural commodity for use by the producer to pay qualified medical expenses.

36. The system of claim 31, wherein the agricultural commodity includes at least one of grain, vegetables, fruit, cotton, and livestock.

37. The system of claim 31, wherein the transaction module reduces the target price in consideration of the pricing information for the non-agricultural input.

38. The system of claim 31, wherein the pricing information for the non-agricultural input comprises a contribution amount by the recipient to at least one of a health investment account and a retirement investment account on behalf of the producer of the agricultural commodity.

39. A method comprising:
selecting a type of commodity;
selecting a number of one or more periods for delivery of the commodity from a producer of the commodity to a recipient;
selecting a quantity of the commodity to be delivered during each of the periods;
selecting a target price for the commodity for each of the periods;
selecting a type of input; and
establishing an amount to be paid by the producer based on one or more of the selections.

40. The method of claim 39, wherein the target price is a target futures price quoted for the commodity.

41. The method of claim 39, wherein the commodity is a non-agricultural commodity.

42. The method of claim 39, wherein the input comprises at least one of agricultural equipment, non-equipment agricultural input, and non-agricultural input.
